(19) United States
(12) Patent Application Publication
(10) Pub. No.: US 2015/0246477 A1
(43) Pub. Date: Sep. 3, 2015

(54) FEATURED SURFACE AND METHOD OF MAKING FEATURED SURFACE

(71) Applicant: ARIEL - UNIVERSITY RESEARCH AND DEVELOPMENT COMPANY, LTD., Ariel (IL)

(72) Inventors: Edward Bormashenko, Ariel (IL); Roman Grynyov, Ariel (IL); Gilad Chaniel, Talmon (IL); Yelena Bormashenko, Ariel (IL); Genady Vayman, Yokneam (IL)

(21) Appl. No.: 14/427,749

(22) PCT Filed: Sep. 12, 2013
(86) PCT No.: PCT/IB2013/058492

§ 371 Date: Mar. 12, 2015

Related U.S. Application Data
(60) Provisional application No. 61/700,360, filed on Sep. 13, 2012.

(51) Int. Cl. B29C 59/02; B32B 3/00

(52) U.S. Cl. CPC B29C 59/02; B32B 3/00; B32B 2307/538; B32B 2307/73; B32B 2307/728

(57) ABSTRACT

Featured surface including a plurality of tapering protrusions, that can be hydrophobic, super hydrophobic and/or oleophobic, superoleophobic, and method for making said surfaces comprising contacting (preferably under heat and pressure) the surface material (preferably, thermoplastic material) with a mesh having micron size voids, and optionally treating the surface with plasma after removing the mesh.

### RELATED APPLICATION

The present application gains priority from U.S. Provisional Patent Application No. 61/700,360 filed 13 Sep. 2012, which is included by reference as if fully set-forth herein.

### FIELD AND BACKGROUND OF THE INVENTION

The invention, in some embodiments, relates to the field of material sciences, and more particularly to methods for treating surfaces of a material (such as of a thermoplastic material), that in some embodiments increase the hydrophobicity and/or the oleophobicity of the surfaces. In some embodiments, the method relates to surfaces having a comparatively high hydrophobicity and/or oleophobicity.

The degree of hydrophobicity of a surface of a material is typical expressed by the contact angle at a material/water interface. A material having a contact angle of less than 90° is considered hydrophilic, a material having a contact angle of greater than 90° is considered hydrophobic and a material having a contact angle of greater than 140° is considered superhydrophobic.

The Young equilibrium contact angle can be established for any material from which a flat, smooth, non-deformable, homogeneous and chemically non-active surface can be made. Specifically, a drop of water is placed on such a surface of the material and the Young contact angle measured, for example using a goniometer. Such materials are typically polymers such as polyethylene, polypropylene or polytetrafluoroethylene.

For powders, chemically heterogeneous surfaces, or rough surfaces (i.e., having nanoscale or larger features, typically described using roughness parameters), the Young contact angle is not defined, and instead, the apparent contact angle is measured. The apparent contact angle is defined as the angle between the tangent to the liquid-film interface and the apparent solid surface as macroscopically observed. For powders, apparent contact angle is often measured by placing a drop of water on a flat adhesive surface (e.g., sticky tape) covered with the powder (see Marmur A “A guide to the equilibrium contact angles maze” in Contact Angle Wettability and Adhesion, V. 6, pp. 3-18, ed. by K. L. Mittal, VSP, Leiden, 2009).

It is often desirable to increase the hydrophobicity and/or oleophobicity of a surface of a material.

### SUMMARY OF THE INVENTION

The invention, in some embodiments, relates to surfaces (in some embodiments of thermoplastic materials), that in some embodiments are hydrophobic, even superhydrophobic, and/or oleophobic, even superoleophobic. In some embodiments, the invention relates to methods for making such surfaces, that in some embodiments increase the hydrophobicity and/or the oleophobicity of the surfaces. The invention, in some embodiments, relates to methods for treating a surface of a material, that in some embodiments increase the hydrophobicity and/or the oleophobicity of the surfaces.

According to an aspect of some embodiments of the invention, there is provided a method of making a featured surface, comprising:

providing a material;

contacting a mesh with a surface of the material;

separating the mesh from the surface to form a plurality of tapering protrusions

protruding from the surface, thereby making a featured surface on the material, wherein the featured surface is substantially more hydrophobic than the inherent hydrophobicity of the material, that is to say, the apparent contact angle of the featured surface with water is substantially greater than the Young equilibrium contact angle of the material. In some embodiments, the featured surface has an apparent contact angle of at least 20°, at least 30°, at least 40°, and even at least 50° greater than the Young equilibrium contact angle of the material.

In some embodiments, the separation between neighboring voids of the mesh is not more than 200 micrometers. In some embodiments, the separation between neighbouring voids of the mesh is not more than 175 micrometers and even not more than 150 micrometers. In some embodiments, the separation between neighboring voids of the mesh is not less than 0.2 micrometers. In some embodiments, the separation between the neighboring voids of the mesh is not less than 0.3 micrometers and even not less than 0.5 micrometers.

In some embodiments, the density of voids of the mesh is not more than 10×10⁶ voids/mm² and in some embodiments not less than 10 voids/mm². In some embodiments, the density of voids of the mesh is not more than 8×10⁶ voids/mm², and even not more than 4×10⁶ voids/mm². In some embodiments, the density of voids of the mesh is not less than 20 voids/mm², and even not less than 25 voids/mm².

In some embodiments, the size of the voids of the mesh is not less than 0.031 micrometer, e.g., a circular void having a 0.1 micrometer radius; not less than 0.071 micrometer², e.g., a circular void having a 0.15 micrometer radius; and even not less than 0.196 micrometer, e.g., a circular void having a 0.25 micrometer radius.

In some embodiments, the size of the voids of the mesh is not more than 17670 micrometer², e.g., a circular void having a 75 micrometer radius; not more than 7850 micrometer², e.g., a circular void having a 50 micrometer radius; and even more than 4420 micrometer², e.g., a circular void having a 37.5 micrometer radius.

In some embodiments, contacting comprises impressing the mesh into the surface, so that at least some of the material constituting the surface enters the voids of the mesh.

In some embodiments, material constituting the surface is in a plastic state during at least part of at least one of the contacting of the mesh with the surface and the separating of the mesh from the surface,

In some embodiments, the material is a thermoplastic material, as listed hereinbelow, for example polyethylene and polypropylene.

In some such embodiments, the method further comprises: heating the surface during at least part of at least one of the contacting the mesh with the surface and the separating the mesh from the surface, so that material contacting the mesh is in a plastic state.

In some such embodiments, the heating of the surface begins subsequent to the contacting of the mesh with the surface and prior to the separating of the mesh from the surface, in some such embodiments so that the material enters a thermoplastic state only after the contact with the mesh begins.

In some embodiments, the heating of the surface begins prior to the contacting of the mesh with the surface, in some such embodiments so that the material is in a thermoplastic state when the mesh first contacts the surface.

In some embodiments: during the contacting of the mesh with the surface of the material, the mesh is located on an inner mold surface of a mold; the contacting of the mesh with the surface of the material is during when the mold is closed; and the separating of the mesh from the surface of the material is during opening of the mold.

In some embodiments, during the contacting of the mesh with the surface of the material, the mesh is located on a contacting surface of a die.

In some embodiments where the mesh is located on a contacting surface of a die: the die is a component of a press (e.g., a stamping press); the contacting of the mesh with the surface of the material is during the lowering of the die to close the press and stamp the surface; and the separating of the mesh from the surface of the material is during the raising of the die to open the press. In some such embodiments, making the protrusions may be considered analogous to the process of coining known in the art of metalworking.

In some embodiments where the mesh is located on a contacting surface of a die: the die is a roller die (e.g., of a roll-former); the contacting of the mesh with the surface of the material begins during initial contact of the surface with the roller die; and the separating of the mesh from the surface is when the surface passes away from the roller die. In some such embodiments, the roller die (e.g., as a component of a roll-former) is functionally associated with the outlet of an extruder, so that the surface of the material contacting the roller die is a freshly-extruded surface, in some embodiments, still in a plastic state from the extrusion process.

In some embodiments, the method further comprises: subsequently to the separating of the mesh from the surface of the material, exposing the featured surface with the plurality of tapering protrusions to a plasma.

In some embodiments, the conditions of the exposure of the featured surface to the plasma are effective in substantially increasing the hydrophobicity of the featured surface, For example, in some embodiments, subsequent to the exposure to plasma, the featured surface has an apparent contact angle with water at least 5°, at least 10°, at least 15°, at least 20°, and even at least 25° greater than the apparent contact angle of the featured surface prior to the exposure to plasma.

In some embodiments, the conditions of the exposure of the featured surface to the plasma are effective in substantially increasing the oleophobicity of the featured surface.

For example in some embodiments, subsequent to the exposure to plasma, the featured surface has an apparent contact angle with dimethylsulfoxide at least 20°, at least 40°, at least 50°, at least 60°, and even at least 65° greater than the apparent contact angle of the featured material prior to the exposure to plasma.

For example in some embodiments, subsequent to the exposure to plasma, the featured surface has an apparent contact angle with N,N-dimethylformamide at least 20°, at least 40°, at least 50°, at least 65°, and even at least 75° greater than the apparent contact angle of the featured material prior to the exposure to plasma.

For example in some embodiments, subsequent to the exposure to plasma, the featured surface has an apparent contact angle with diiodomethane at least 20°, at least 40°, at least 60°, at least 80°, and even at least 100° greater than the apparent contact angle of the featured material prior to the exposure to plasma.

In some embodiments, the plasma comprises a cold plasma, in some embodiments a cold radiofrequency plasma.

In some embodiments, the cold radiofrequency plasma is generated in an atmosphere of a gas by a radiofrequency field having a frequency of not less than about 100 kHz.

In some embodiments, the cold radiofrequency plasma is generated in an atmosphere of a gas by a radiofrequency field having a frequency of not more than about 100 MHz.

In some embodiments, the atmosphere is substantially devoid of fluorocarbons.

In some embodiments, the atmosphere comprises fluorocarbons.

In some embodiments, the featured surface is exposed to the plasma for not less than about 1 second. In some embodiments, the featured surface is exposed to the plasma for not more than about 60 minutes.

According to an aspect of some embodiments of the invention, there is also provided a man-made featured surface, comprising:

as features, a plurality of tapering protrusions protruding from a surface,
wherein the surface and the protrusions are of a same material,
the protrusions having a length of not more than 1000 micrometers and not less than 0.5 micrometers;
wherein a density of the protrusions on the surface is not less than 10 protrusions/mm²; and
wherein neighboring protrusions on the surface are separated by a center to center distance of not more than 200 micrometers and not less than 0.2 micrometers

In some embodiments, the featured surface is substantially more hydrophobic than the inherent hydrophobicity of the material, that is to say, the apparent contact angle of the featured surface with water is substantially greater than the Young equilibrium contact angle of the material. In some embodiments, the featured surface has an apparent contact angle at least 20°, at least 30°, at least 40°, and even at least 50° greater than the Young equilibrium contact angle of the material.

In some embodiments, the material is hydrophobic (having a Young equilibrium contact angle between 90° and 140°), and the featured surface is superhydrophobic (having an apparent contact angle greater than 140°).

In some embodiments, the material is hydrophilic (having a Young equilibrium contact angle less than 90°), and the featured surface is hydrophobic (having an apparent contact angle greater than 90°).

In some embodiments, the material is hydrophilic (having a Young equilibrium contact angle of less than 90°) and the featured surface is superhydrophobic (having an apparent contact angle greater than 140°).

In some embodiments, the length of the protrusions is not more than 500 micrometers, not more than 200 micrometers and even not more than 100 micrometers. In some embodiments, the length of the protrusions is not less than 2 micrometers, not less than 5 micrometers and even not less than 10 micrometers.

In some embodiments, a density of the protrusions on the featured surface is not more than 10×10⁶ protrusions/mm², not more than 8×10⁶ protrusions/mm², and even not more than 4×10⁶ protrusions/mm². In some embodiments, a density of the protrusions on the surface is not less than 20 protrusions/mm², and even not less than 25 protrusions/mm².

In some embodiments, neighboring protrusions on the featured surface are separated by a center to center distance of not more than 175 micrometers and even not more than 150 micrometers, In some embodiments, neighboring protrusions on the surface are separated by a center to center distance of not less than 0.3 micrometers and even not less than 0.5 micrometers.

In some embodiments, the protrusions have a base size of not less than 0.031 micrometer², e.g., a circular base having a 0.1 micrometer radius; not less than 0.071 micrometer², e.g., a circular base having a 0.15 micrometer radius; and even not less than 0.196 micrometer², e.g., a circular base having a 0.25 micrometer radius.

In some embodiments, the protrusions have a base size of not more than 17670 micrometer², e.g., a circular base having a 75 micrometer radius; not more than 7850 micrometer², e.g., a circular base having a 50 micrometer radius; and even more than 4420 micrometer², e.g., a circular base having a 37.5 micrometer radius.

In some embodiments, the material is a man-made material.

In some embodiments, the material is a thermoplastic material, such as listed below, for example, polyethylene or polypropylene.

In some embodiments, the protrusions are substantially uncoated and the outer surface thereof is of the material. In some such embodiments, the protrusions are substantially smooth on a nanometric scale. (e.g., 10 to 100 nanometer scale).

In some embodiments, the surfaces of the protrusions have nanometric roughness, e.g., as a result of etching, e.g. by contact with plasma, such as cold plasma, such as cold radiofrequency plasma. In some such embodiments, the roughness comprises features having dimensions of a 10 to 100 nanometer scale.

In some embodiments, the surfaces of the protrusions include bonded atoms different from the material. In some embodiments, the bonded atoms comprise fluorine atoms.

According to an aspect of some embodiments of the invention, there is also provided an item of manufacture, comprising a featured surface according to the teachings herein.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

As used herein, the term “forming” is used as a synonym to the term “generating” as used in U.S. 61/700,360, a priority document of the application.

As used herein, when a numerical value is preceded by the term “about”, the term “about” is intended to indicate +/−10%.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIG. 1 is a reproduction of a SEM image (×95) of a mesh used for implementing an embodiment of the teachings herein;

FIGS. 2A, 2B and 2C are reproductions of SEM images (×110, ×250 and ×2700, respectively) of an embodiment of a surface according to the teachings herein;

FIG. 3A is a reproduction of a SEM image (×2700) of an embodiment of a surface according to the teachings herein;

FIGS. 3B and 3C are reproductions of SEM images (×2700 and ×700, respectively) of an embodiment of a surface according to the teachings herein after exposure to cold-radiofrequency plasma;

FIGS. 4A and 4B are SEM/EDS spectra of a surface according to the teachings herein without exposure to plasma (4A) and after exposure to plasma (4B);

FIG. 5 is a reproduction of an image of a water droplet on a surface according to the teachings herein without exposure to plasma;

FIG. 6 (prior art) is a graph showing the dependence of the surface tension of a water/ethanol solution on the concentration of ethanol;

FIG. 7 is graph showing the contact angle of a water/ethanol droplet as a function of the ethanol concentration in the droplet for a surface according to the teachings herein without exposure to plasma (O), a surface according to the teachings herein after exposure to plasma (X) and a surface according to the teachings herein 9 days after exposure to plasma (squares); and

FIG. 8 is a reproduction of an image of a diiodomethane droplet on a surface according to the teachings herein after exposure to plasma.

### DESCRIPTION OF SOME EMBODIMENTS OF THE INVENTION

The invention, in some embodiments, relates to featured surfaces (in some embodiments of thermoplastic materials), that in some embodiments are hydrophobic, even superhydrophobic, and/or oleophobic, even superoleophobic. In some embodiments, the invention relates to methods for making such featured surfaces, that in some embodiments increase the hydrophobicity and/or the oleophobicity of the featured surfaces. The invention, in some embodiments, relates to methods for treating a surface of a material, that in some embodiments increase the hydrophobicity and/or the oleophobicity of the surfaces.

It is often desired to increase the hydrophobicity and/or oleophobicity of a surface of a material, for instance, of a thermoplastic material.

### Increased Hydrophobicity

According to an embodiment of the teachings herein, a mesh that is in contact with a surface of a material (in some embodiments, a thermoplastic material) in a plastic state is separated from the surface so as to form a plurality of tapering protrusions protruding from the surface.

In some embodiments, the surface is of a thermoplastic material and is heated to be in a plastic state. The exact temperature to which a surface of a given thermoplastic material must be heated to be in a plastic state is well-known to a person having ordinary skill in the art and can be found by consulting standard industrial reference books.

As used herein, a mesh is a component having a surface, including a plurality of solid links meeting at plurality of solid nodes, so that the areas between the links and nodes define a plurality of discrete voids. In typical embodiments, the mesh is permeable or semi-permeable to a fluid, typically because the voids pass through the mesh. In some embodiments, the mesh is impermeable and the discrete voids are substantially depressions in a surface defined by links and nodes

When implementing the teachings herein, when the mesh contacts the surface to be treated in a plastic state, the mesh is at least partially impressed into the surface, so that at least some of the material making up the surface enters the voids between the links and nodes of the mesh.

In some embodiments, the mesh is contacted with a surface of thermoplastic material, the surface of thermoplastic material is subsequently heated to a plastic state so that the mesh is impressed therein, and the mesh is subsequently separated from the surface.

In some embodiments, the surface of a thermoplastic material is heated to a plastic state, subsequently the mesh is contacted with the thermoplastic surface and impressed therein, and subsequently the mesh is separated from the surface.

In some embodiments, the method is implemented in a mold which inner mold surface at least partially includes a mesh.

In some embodiments, the method is implemented with a die, for example in a press having a die (e.g., stamping press) which contacting surface at least partially includes a mesh.

In some embodiments, the method is implemented with a roller die, for example in a roll former having a roller die which contacting surface at least partially includes a mesh.

In some embodiments, the method is implemented by functional-association with an extruder, where the surface of an extruded thermoplastic material in a plastic state is contacted with the mesh (e.g., which is located on a contact surface of a roller die), thereby allowing continuous production of a surface according to the teachings herein.

When the mesh is separated from the surface, some of the material that had previously been found in the voids of the mesh is drawn out, producing the tapering protrusions. Due to the fact that separation of the mesh and surface occurs when the surface is in a plastic state, the material constituting the tapering protrusions sets (for thermoplastic materials by cooling) to a non-plastic (fixed) state.

The resulting featured surface in accordance with the teachings herein is of a material from which protrude a plurality (in some embodiments, not less than 50, not less than 100, and even not less than 1000) of tapering protrusions. The protrusions are typically smooth on a 10-100 nanometer scale.

It has been found that in some embodiments, a featured surface in accordance with the teachings herein has an increased hydrophobicity compared to the inherent hydrophobicity of a surface of the same material. In some embodiments, a featured surface in accordance with the teachings herein is superhydrophobic.

### Length of Protrusions

The length of the protrusions of a featured surface according to the teachings herein is dependent on various factors such as the size of the voids of the mesh, the nature of the material and especially for thermoplastic materials, the temperature of the surface during the separation of the mesh. That said, in some embodiments the length of the protrusions is not more than 1000 micrometers, not more than 500 micrometers, not more than 200 micrometers and even not more than 100 micrometers. In some embodiments, the length of the protrusions is not less than 0.5 micrometers, not less than 2 micrometers, not less than 5 micrometers and even not less than 10 micrometers.

### Distance Between Neighboring Protrusions

The distance (center to center) between any two protrusions of a featured surface according to the teachings herein is any suitable distance.

That said, in some embodiments, a featured surface according to the teachings herein includes a plurality of tapering protrusions, neighboring protrusions separated by a center to center distance of not more than 200 micrometers, not more than 175 micrometers and even not more than 150 micrometers.

In some embodiments, a featured surface according to the teachings herein includes a plurality of tapering protrusions, neighboring protrusions separated by a center to center distance of not less than 0.2 micrometers, not less than 0.3 micrometers and even not less than 0.5 micrometers.

### Density of Protrusions

The density of protrusions (in protrusions/mm²) of a featured surface according to the teachings herein is any suitable density.

That said, in some embodiments, a featured surface according to the teachings herein has a plurality of tapering protrusions with a density of not more than 10×10⁶ protrusions/mm², not more than 8×10⁶ protrusions/mm², and even not more than 4×10⁶ protrusions/mm².

In some embodiments, a featured surface according to the teachings herein has a plurality of tapering protrusions with a density of not less than 10 protrusions/mm², not less than 20 protrusions/mm², and even not less than 25 protrusions/mm².

### Size of Base of Protrusions

The size of the base of the protrusions of a featured surface according to the teachings herein is an suitable base-size.

That said, in some embodiments, a featured surface according to the teachings herein includes a plurality of tapering protrusions having a base size of not less than 0.031 micrometer², e.g., a circular base having a 0.1 micrometer radius; not less than 0.071 micrometer², e.g., a circular base having a 0.15 micrometer radius; and even not less than 0.196 micrometer², e.g., a circular base having a 0.25 micrometer radius.

In some embodiments, a featured surface according to the teachings herein includes a plurality of tapering protrusions having a base size of not more than 17670 micrometer², e.g., a circular base having a 75 micrometer radius; not more than 7850 micrometer², e.g., a circular base having a 50 micrometer radius; and even more than 4420 micrometer, e.g., a circular base having a 37.5 micrometer radius.

### Mesh

As noted above, a mesh used in implementing the teachings herein is a component having a surface, including a plurality of solid links meeting at plurality of solid nodes, so that the areas between the links and nodes define a plurality of discrete voids. In typical embodiments, the mesh is permeable or semi-permeable to a fluid.

A mesh (in some embodiments, a gauze) used for implementing the teachings herein is any suitable mesh. In some embodiments, the mesh is formed from a plurality of intersecting strands (e.g., of metal or fiber) where the intersections of the strands define the nodes of the mesh, and the strand between the nodes define the links of the mesh. In some embodiments the mesh is fashioned of woven strands.

In some embodiments, the voids are homogeneous, that is to say, substantially all the voids are of substantially the same size. In some embodiments, the voids are heterogeneous, that is to say, the mesh includes at least two populations of voids having the same size, each population of different-sized voids.

The portion of a mesh surface area that is of the voids is any suitable portion. That said, in some embodiments the portion is not less than 2%, not less than 3%, not less than 5% and even not less than 20% void. In some embodiments, the portion is not greater than 80%, not greater than 70% and even not greater than 65% void.

The dimensions of the protrusions of a featured surface according to the teachings herein are in a large part determined by the characteristics of the mesh used in making the featured surface.

The separation between any two neighboring protrusions of a featured surface according to the teachings herein is determined, inter alia, by characteristics of the mesh used in making the featured surface, specifically the separation (center to center) between any two neighboring voids and the density of the protrusions, that is determined, inter alia, by the size (diameter) of the voids (that also determines the size of the base of the protrusions) and the width of the link separating the voids (that also determines the distance between the centers of any two neighboring protrusions). For making a given featured surface in accordance with the teachings herein, a mesh having suitable characteristics is selected.

### Separation Between Neighboring Voids

As noted above, the separation (center to center) of neighboring protrusions of a featured surface according to the teachings herein is largely determined by the separation (center to center) of neighboring voids of a mesh used for making the featured surface.

A mesh having any suitable separation between neighboring voids may be used in implementing the teachings herein.

That said, in some embodiments, the separation between neighboring voids of a mesh used in making a featured surface according to the teachings herein is not more than 200 micrometers, not more than 175 micrometers and even not more than 150 micrometers.

In some embodiments, the separation between neighboring voids of a mesh used in making a featured surface according to the teachings herein is not less than 0.2 micrometers, not less than 0.3 micrometers and even not less than 0.5 micrometers.

### Density of Voids

As noted above, the density of protrusions of a featured surface according to the teachings herein is largely determined by the density (voids/mm²) of a mesh used for making the featured surface.

A mesh having any suitable density of voids may be used in implementing the teachings herein.

That said, in some embodiments the density of voids of a mesh is not more than 10×10⁶ voids/mm², not more than 8×10⁶ voids/mm², and even not more than 4×10⁶ voids/mm².

In some embodiments the density of voids of a mesh is not less than 10 voids/mm², not less than 20 voids/mm², and even not less than 25 voids/mm².

### Size of Voids

As noted above, the size of the base of protrusions of a featured surface according to the teachings herein is largely determined by the size of the voids of a mesh used for making the surface.

A mesh having any suitable void size (measured in parallel to a plane defined by the void-defining nodes) may be used in implementing the teachings herein.

That said, in some embodiments, the size of a void of a mesh used in making a featured surface according to the teachings herein is not less than 0.031 micrometer, e.g., a circular void having a 0.1 micrometer radius; not less than 0.071 micrometer, e.g., a circular void having a 0.15 micrometer radius; and even not less than 0.196 micrometer, e.g., a circular void having a 0.25 micrometer radius.

In some embodiments, the size of a void of a mesh used in making a featured surface according to the teachings herein is not more than 17670 micrometer, e.g., a circular void having a 75 micrometer radius; not more than 7850 micrometer, e.g., a circular void having a 50 micrometer radius; and even more than 4420 micrometer, e.g., a circular void having a 37.5 micrometer radius.

### Thermoplastic Materials

A featured surface of any suitable material may be used for implementing the teachings herein.

In some embodiments, the featured surface is of a thermoplastic material. A surface of any suitable thermoplastic material may be used for implementing the teachings herein. In some embodiments, the thermoplastic material is a hydrocarbon polymer, in some embodiments a fluorinated hydrocarbon polymer.

In some embodiments, the thermoplastic material is selected from the group consisting of Acrylonitrile butadiene styrene (ABS), Acrylic (PMMA), Celluloid, Cellulose acetate, Cyclic Olefin Copolymer (COC), Ethylene-Vinyl Acetate (EVA), Ethylene vinyl alcohol (EVOH), Fluoroplastics (PTFE, alongside with FEP, PFA, CTFE, ECTFE, ETFE), Ionomers, Kydex, a trademarked acrylic/PVC alloy, Liquid Crystal Polymer (LCP), Polyoxymethylene (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Chlorinated Polyethylene (CPE), Polyimide (PI), Polylactic acid (PLA), Polymethylpentene (PMP), Polyphenylene oxide (PPO), Polyphenylene sulfide (PPS), Polyphthalamide (PPA), Polypropylene (PP), Polystyrene (PS), Polysulfone (PSU), Polytrimethylene terephthalate (PTT), Polyurethane (PU), Polyvinyl acetate (PVA), Polyvinyl chloride (PVC), Polyvinylidene chloride (PVDC) and Styrene-acrylonitrile (SAN).

As noted above, it has been found that in some embodiments, a featured surface in accordance with the teachings herein has an increased hydrophobicity compared to the inherent hydrophobicity of a surface of the same material, that is to say, in some embodiments the apparent contact angle of a featured surface of a material in accordance with the teachings herein is substantially higher than the Young equilibrium contact angle of the material. The Young equilibrium contact angles of some typical thermoplastic materials that can be used for implementing the teachings herein are listed in Table 1.

TABLE 1
Young equilibrium contact angles of typical thermoplastic materials

| | Young equilibrium |
|---|---|
| material | contact angle [°] |
| Polyvinyl alcohol (PVOH) | 51.0 |
| Polyvinyl acetate (PVA) | 60.6 |
| Nylon 6 | 62.6 |
| Polyethylene oxide (PEO, PEG, | 63.0 |
| polyethylene glycol) | |
| Nylon 6,6 | 68.3 |
| Nylon 7,7 | 70.0 |
| Polysulfone (PSU) | 70.5 |
| Polymethyl methacrylate (PMMA, acrylic) | 70.9 |
| Nylon 12 | 72.4 |
| Polyethylene terephthalate (PET) | 72.5 |
| Epoxies | 76.3 |
| Polyoxymethylene (POM, | 76.8 |
| polymethylene oxide, acetal) | |
| Polyvinylidene chloride (PVDC, Saran) | 80.0 |
| Polyphenylene sulfide (PPS) | 80.3 |
| Acrylonitrile butadiene styrene (ABS) | 80.9 |
| Nylon 11 | 82.0 |
| Polycarbonate (PC) | 82.0 |
| Polyvinyl fluoride (PVF) | 84.5 |
| Polyvinyl chloride (PVC) | 85.6 |
| Nylon 8,8 or Nylon 9,9 | 86.0 |
| Polystyrene (PS) | 87.4 |
| Polyvinylidene fluoride (PVDF) | 89.0 |
| Poly n-butyl methacrylate (PnBMA) | 91.0 |
| Polytrifluoroethylene | 92.0 |
| Nylon 10,10 | 94.0 |
| Polybutadiene | 96.0 |
| Polyethylene (PE) | 96.0 |
| Polychlorotrifluoroethylene (PCTFE) | 99.3 |
| Polypropylene (PP) | 102.1 |
| Polydimethylsiloxane (PDMS) | 107.2 |
| Poly t-butyl methacrylate (PtBMA) | 108.1 |
| Fluorinated ethylene propylene (FEP) | 108.5 |
| Hexatriacontane | 108.5 |
| Polytetrafluoroethylene (PTFE) | 109.2 |
| Poly(hexafluoropropylene) | 112.0 |
| Polyisobutylene (PIB, butyl rubber) | 112.1 |

### Increased Oleophobicity

In some embodiments, it is desirable to even further increase the hydrophobicity and/or oleophobicity of a surface from which protrude a plurality of tapering protrusions as described hereinabove.

It has been found that in some embodiments the hydrophobicity and/or oleophobicity of a surface as described hereinabove is increased by exposure to a cold (radiofrequency) plasma, especially a cold plasma generated from a fluorocarbon atmosphere. The sides of the tapering protrusions are etched and no longer smooth, exhibiting nanoscale (e.g., 10 to 100 nanometer, e.g., nodules vide infra) features. In addition, in some embodiments where the plasma is generated from a fluorocarbon atmosphere, at least some fluorine atoms are integrated into the surface. Although not wishing to be held to any one theory, it is believed that the increased hydrophobicity (in some embodiments superhydrophobicity) and/or increased oleophobicity (in some embodiments superoleophobicity) is a consequence of the nanoscale features and/or the fluorination of the surface. It has been also found that the observed (super)oleophobicity increases with time, apparently as a result of a mechanism related to hydrophobic recovery.

A featured surface of a material from which protrude a plurality of tapering protrusions as described hereinabove of any suitable material can be exposed to plasma as described herein, for example, any of the thermoplastic materials described above, especially polyethylene and polypropylene.

In some embodiments, the exposure to plasma is batchwise, that is to say one or more items including a surface as described hereinabove are placed in a chamber, plasma is generated in or introduced into the chamber, thereby exposing the surface to the plasma, and subsequently, the items are removed from the chamber.

In some embodiments, the exposure to plasma is continuous, for example, a thermoplastic material is extruded, then contacted with a mesh as described above, for example with a roller-die bearing the mesh to produce the plurality of tapering protrusions as described above, and subsequently, a plasma generator generates the required plasma above the featured surface, thereby exposing the surface and tapering protrusions to the plasma.

### Type of Plasma

In some embodiments, the plasma to which the featured surface is exposed is cold plasma, for example inductively coupled plasma, for example generated using a radiofrequency current, that is to say, the plasma is a cold radiofrequency glow discharge plasma (also called herein, cold radiofrequency plasma, for example using a radiofrequency glow discharge plasma source). In such embodiments, any suitable radiofrequency field having any suitable frequency is used to generate the plasma. In some embodiments, the plasma is generated by a radiofrequency field having a frequency of not less than about 100 KHz, not less than about 250 kHz, not less than about 500 kHz, not less than 1 MHz., not less than about 3 MHz and even not less than about 5 MHz. In some embodiments, the plasma is generated by a radiofrequency field having a frequency of not more than about 100 MHz. In some embodiments, the plasma is generated by a radiofrequency field having a frequency of not more than about 80 MHz, not more than about 50 MHz, not more than about 20 MHz, even not more than about 15 MHz and even not more than 13 MHz. In some embodiments, the plasma is generated by a radiofrequency field having a frequency of between about 1 MHz and about 15 MHz, and even between about 5 MHz and about 14 MHz, for example about 10 MHz or about 13.56 MHz.

In some embodiments, other suitable methods and plasma-generating devices are used to generate cold plasma to which a featured surface is exposed in accordance with the teachings herein. In some embodiments, the method of generating the plasma is selected from the group consisting of electron cyclotron resonance (using an electron cyclotron resonance plasma source); corona discharge plasma (using a corona discharge plasma source), atmospheric arc plasma (using an atmospheric arc plasma source, “plasma spray torch”), vacuum arc plasma (using a vacuum arc plasma source), laser-generated plasma (using a laser plasma source). Details of various plasma sources are known in the art (see for example, Chu P K, Chen J Y, Wang L P, Huang N “Plasma-surface modification of biomaterials” Mat Sci and Eng 2002, R36, 143-206, which is included by reference as if fully set forth herein).

### Duration

In some embodiments, the featured surface is exposed to the plasma for not less than 1 second, not less than 1 minute, and even not less than 10 minutes. In some embodiments, the featured surface is exposed to the plasma for not more than 60 minutes, not more than 45 minutes, and even not more than 30 minutes. Short exposure allows saving in energy used to generate the plasma and allows greater throughput, especially when implementing continuous (as opposed to batch) exposure, for example, during an extrusion process.

### Atmosphere

In some embodiments, the surface is exposed to the plasma generated from an atmosphere from which the plasma is generated.

In such embodiments, the pressure of the atmosphere from which the plasma is generated (as measured just prior to generation of the plasma) is any suitable pressure. Radiofrequency glow discharge plasma is typically divided into low-pressure (between about 0.133 Pa (10⁻³ Torr) and 133 Pa (1 Torr)) and medium-pressure (between 133 Pa and 13300 Pa (100 Torr), where the electron density in the generated plasma increases with higher pressure.

In some embodiments, the pressure of the atmosphere from which the plasma is generated is not more than about 500 Pa and even not more than about 250 Pa. In some embodiments, the pressure of the atmosphere from which the plasma is generated is low-pressure, that is to say not more than about 133 Pa, and in some embodiments, and not more than about 100 Pa, not more than about 50 Pa and even not more than about 20 Pa.

In some embodiments it has been found that superior results are achieved at very low pressures, that is to say not more than about 10 Pa, not more about than about 8 Pa, not more than about 5 Pa and even not more about than 2 Pa. Although not wishing to be held to any one theory, it is believed that in some embodiments, the electron density of the plasma at such very low pressures results in superior results.

In some embodiments, the atmosphere comprises oxygen (O₂). In some embodiments, the molar percent of oxygen in the atmosphere is not less than 0.1%, not less than 1%, not less than 5%, not less than 10% and even not less than 20% oxygen.

In some embodiments, the atmosphere comprises nitrogen (N₂). In some embodiments, the molar percent of nitrogen in the atmosphere is not less than 0.1%, not less than 1%, not less than 5%, not less than 10% and even not less than 20% nitrogen.

In some embodiments, the atmosphere comprises oxygen together with an inert gas (e.g., N₂, Ne, Ar, He or mixtures thereof). In some embodiments, the molar percent of the oxygen and the inert gas together comprises not less than 5%, not less than 10%, not less than 20%, not less than 40%, not less than 60%, not less than 80%, and even not less than 95% of the atmosphere.

In some embodiments, the atmosphere is air.

In some embodiments, the atmosphere comprises an inert gas (e.g., N₂, Ne, Ar, He and mixtures thereof) and includes less than 0.1% molar percent) of oxygen.

In some embodiments, the atmosphere is substantially devoid of fluorocarbons. In some such embodiments, the hydrophobicity and/or oleophobicity of the surfaces increases due to the etching of the surface and the protrusions.

In some embodiments, the atmosphere comprises a fluorocarbon, especially a fluorocarbon alkane of the formula F_{X}H_{2X}H_{2-Y}F_{Y}, where Y is an integer between 1 and 2X+2. In some such embodiments, the fluorocarbon is a fluorinated methane (i.e., at least one of CH₃F, CH₂F₂, CHF₃ and CF₄) and/or a fluorinated ethane (i.e., at least one of C₂H₅F, C₂H₄F₂, C₂H₃F₃, C₂H₂F₄, C₂H₁F₅ and C₂F₆). In some embodiments, the molar percent of fluorocarbons comprises not less than 5%, not less than 10%, not less than 20%, not less than 40%, not less than 60%, not less than 80%, and even not less than 95% of the atmosphere.

### EXPERIMENTAL

### Materials

Low density polyethylene (LDPE) pellets were supplied by Carmel Olefins Ltd., Israel; Dimethylsulfoxide (DMSO, (CH₃)₂SO by Merck; N,N-Dimethylformamide, (CH₃)₂NC(O)H by Bio-Lab Ltd Israel; Diiodomethane, CH₂I₂ by Sigma-Aldrich; Ethanol (Dehydrated), C₂H₅OH by Bio-Lab Ltd Israel. Gaseous tetrafluoromethane (CF₄, CAS Nr. 75-73-0) was supplied by Linde Electronics and Specialty Gases.

### Increasing Hydrophobicity of a Thermoplastic Surface

A 1 mm thick polyethylene sheet was fabricated by extrusion of the polyethylene with single screw extruder (RCP-0750).

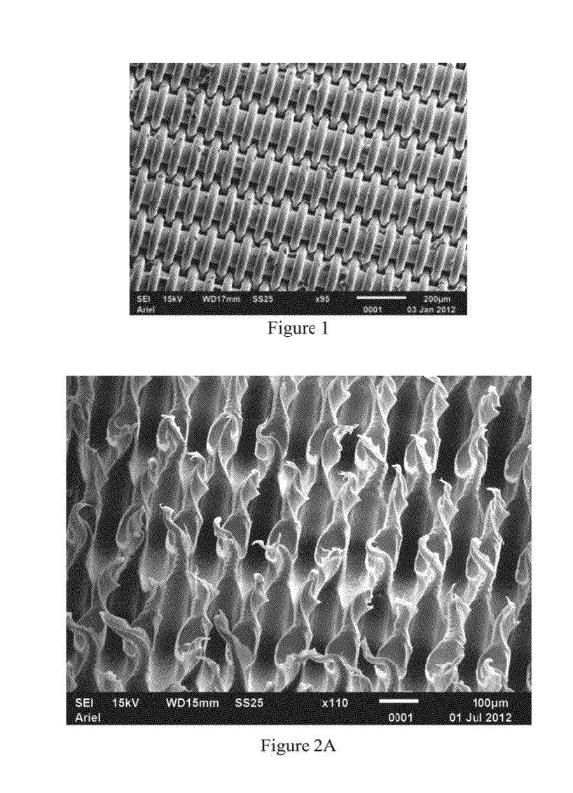

A commercially-available woven stainless steel mesh was acquired from A.D. Sinun (Israel). The weave was a plain weave having 120 micrometer stainless steel wire warp and 40 micrometer stainless steel wire weft. A SEM image of the mesh is reproduced in FIG. 1 (×95, scale-bar is 200 micrometer). The mesh includes a plurality of roughly square voids 20×20 micrometer each having an area of 400 micrometer², each void defined between a warp wire and three weft wires.

The mesh was secured facing down to the bottom face of a 10 cm×10 cm upper steel die plate of a manually-operated hydraulic press (P/N 15011/25011) using heat-proof epoxy adhesive, constituting a contacting surface of a die.

The polyethylene sheet was placed on the lower steel plate of the hydraulic press. The press was activated to apply a pressure of about 10 MPa while heating the plates to 105° at which the surface of the polyethylene sheet was in a plastic state, so that the mesh contacted the polyethylene surface and was partially impressed thereinto.

The hydraulic press was opened, thereby separating the mesh from the polyethylene sheet and forming a plurality of protrusions protruding from the surface. The plastic sheet was allowed to air cool to ambient temperature.

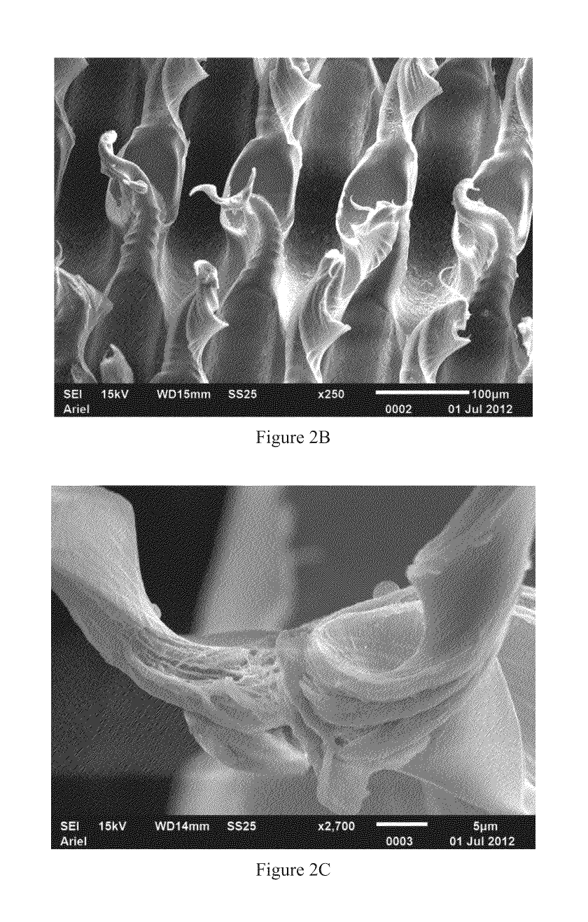

The resulting featured surface of the sheet was examined under a scanning electron microscope (JSM-6510LV by JEOL Ltd., Tokyo, Japan), showing a plurality of smooth tapering protrusions, see FIG. 2A (×110, scale bar=100 micrometer), FIG. 2B (×250, scale bar=100 micrometer) and FIG. 2C (×2700, scale bar=5 micrometer).

### Exposing the Featured Surface to Plasma

The polyethylene sheet having the featured surface with tapering protrusions made above was exposed to cold radiofrequency plasma generated in an atmosphere of tetrafluoromethane (CF₄).

A cylindrical inductively-coupled plasma device (PDC-32G by Harrick Plasma, Ithaca. N.Y., USA) was acquired. The device has a 7.62 cm (3″) diameter by 16.51 cm (6.5″) long cylindrical Pyrex chamber, a gas inlet port (⅛″ NPT needle valve to qualitatively control gas flow and chamber pressure), a three-way port (⅛″ NPT 3-way valve to quickly switch from bleeding in gas, isolating the chamber, and pumping) and a helical electrode. A vacuum pump (PDC-OPD-2 by Harrick Plasma, Ithaca, N.Y., USA) was functionally associated with device through the three-way port to allow evacuation of the gaseous contents of the chamber.

A sample of the polyethylene sheet as described above was placed in the chamber.

The chamber was evacuated and then filled with CF₄ at a pressure 6.7×10⁻² Pa.

The radiofrequency power source of the device was activated to generate a 18W 10 MHz radiofrequency current for a time of from 10 to 30 minutes, ionizing components of the CF₄ gas in the chamber to generate plasma therein.

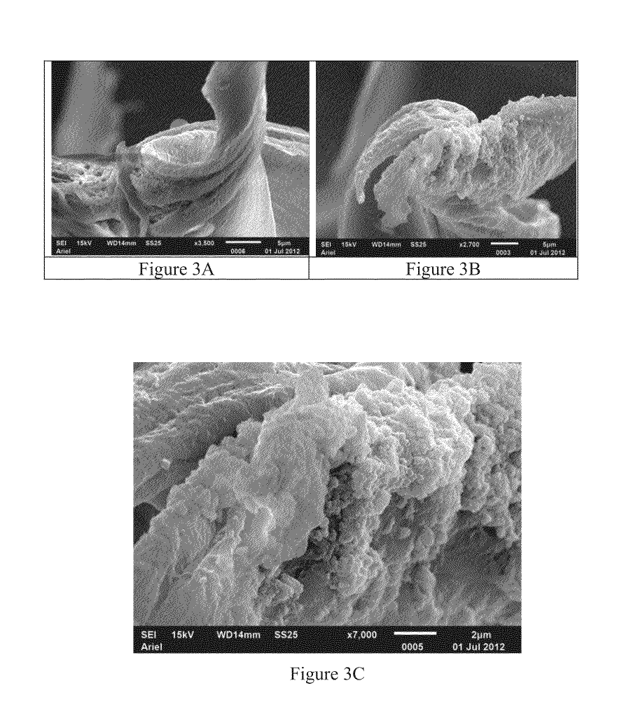

The featured surface of the sheet after exposure to the cold plasma was examined under the scanning electron microscope. The etching and concomitant nanoscale features (including nodules) were clearly visible, compare the surface prior to exposure to the plasma in FIG. 3A (×2700, scale bar=5 micrometer) and subsequent to exposure to plasma in FIG. 3B (×2700, scale bar=5 micrometer) and FIG. 3C (×7000, scale bar 2 micrometer).

### Wetting Properties

The wetting properties of the two featured polyethylene surfaces according to the teachings herein described above were studied by measuring the apparent contact and sliding angles of droplets of various liquids placed thereupon. Apparent contact angles were measured using a Ramé-Hart Advanced Goniometer Model 500-F1. Sliding angles were measured using a lab-made tilt table used together with the goniometer.

Droplets of various liquids were placed on the surfaces and the apparent contact angle measured. The results are found in Table 2.

TABLE 2
Wetting properties of the featured surfaces

| | Apparent | Apparent |
|---|---|---|
| | contact angle, | contact angle, |
| Liquid | no-plasma exposure [°] | plasma exposure [°] |
| Water | 153 ± 3 | 180 |
| Dimethylsulfoxide | 77 ± 3 | 142 ± 4 |
| N,N-Dimethylformamide | 42 ± 3 | 123 ± 3 |
| Diiodomethane | 33 ± 3 | 143 ± 2 |

### Chemical Composition

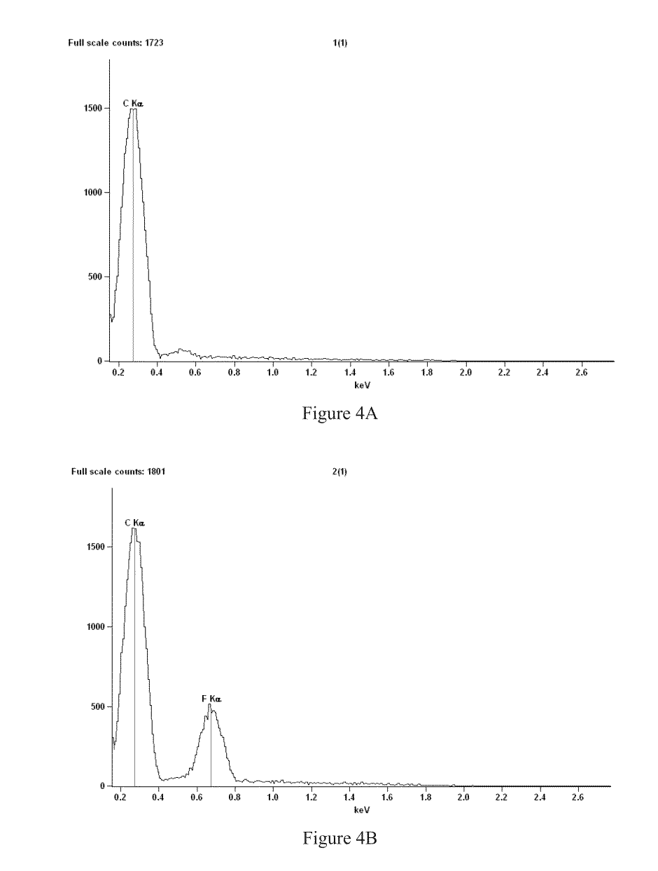

The chemical composition of the two surfaces was studied with SEM/EDS (scanning electron microscope/energy dispersive spectrometer) carried out with the SEM (JSM-6510 LV). The results are depicted in FIG. 4A (featured surface not exposed to plasma) and FIG. 4B (featured surface exposed to plasma). As seen in FIG. 4B, distinct fluorine peaks indicate incorporation of fluorine into the featured surface as a result of exposure to plasma.

### Results and Discussion

### Surface not Exposed to Plasma

Contact of a mesh (FIG. 1) with the polyethylene surface led to the formation of protrusions as seen in FIGS. 2A, 2B and 2C. As seen in Table 2, the hydrophobicity of the surface increased from a slightly hydrophobic Young equilibrium contact angle of 96° to the superhydrophobic 153±3° and having a sliding contact angle of close to zero. In FIG. 5, a 5 microliter droplet of water is shown resting on the surface. Although not wishing to be held to any one theory, it is believed that as a result of the protrusions, the surface exhibits Cassie-Baxter wetting behavior (A. B. D. Cassie, S. Baxter, Trans. Faraday Soc. 40 (1944) 546-551 and E. Bormashenko, Philosophical Transactions of the Royal Society A 368 (2010) 4673). As seen from Table 2, the surface is oleophilic.

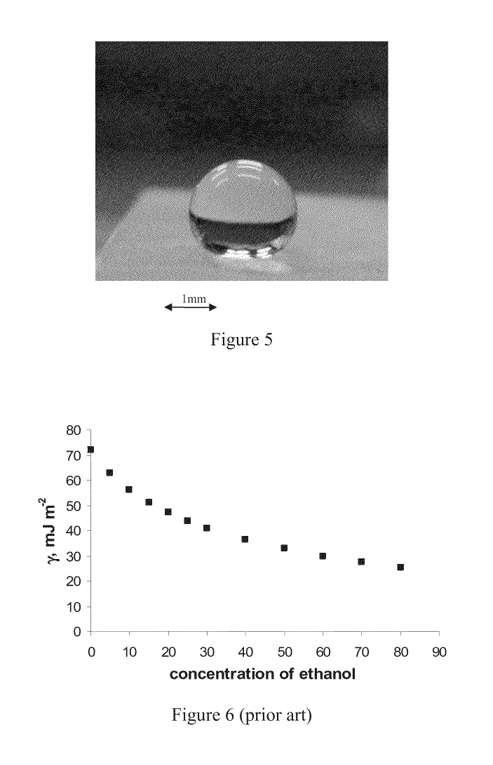

In order to estimate the stability of the Cassie wetting relative to deposition of organic liquids, methods described in the art (J. B. Boreyko, Ch. H. Baker, C. R. Poley, Ch.-H. Chen, Langmuir 27 (2011) 7502 and E. Bormashenko, R. Baiter, D. Aurbach, Journal of Colloid and Interface Science (2012), doi: http://dx.doi.org/10.1016/j.cis.2012.06.023) were used. 5 microliter droplets of water/ethanol solutions were deposited on the surface. The concentration of ethanol in the solution was increased gradually in a step of 5 wt %. In FIG. 6, a graph showing the dependence of the surface tension of a water/ethanol solutions on the concentration (wt %) of the ethanol is depicted, taken from G. V'azquez, E. Alvarez, J. M. Navaza, J. Chem. Eng. 40 (1995) 611.

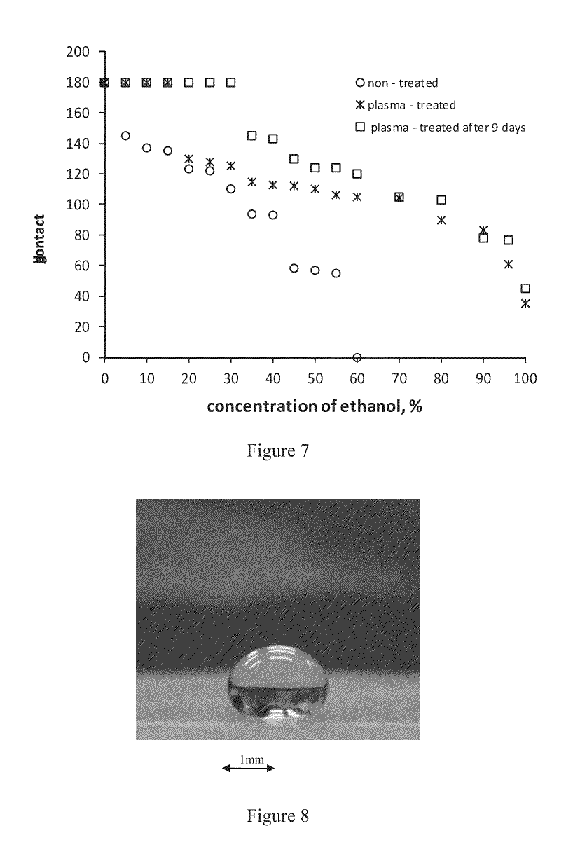

In FIG. 7, the apparent contact angle of a droplet is plotted against the ethanol concentration in the droplet. The circles correspond to measurements for the polyethylene surface not exposed to plasma. The progressive reduction of apparent contact angle with reduced droplet surface tension indicates that the initial Cassie wetting regime gradually changes to the “sticky” Wenzel regime. Starting from a 10 wt % ethanol concentration (corresponding to a surface tension of 58.18 mJ/m2), the droplets did not roll and passed to a “sticky” (Wenzel or, perhaps, Cassie impregnating (E. Bormashenko, Philosophical Transactions of the Royal Society A 368 (2010) 4673) wetting state.

### Surface Exposed to Plasma

As noted above, a polyethylene surface with protrusions as described hereinabove was exposed to cold radiofrequency plasma generated in a CF₄ atmosphere that etched the protrusions, leading to the nanoscale roughness seen in FIGS. 3B and 3C.

Nanoscale changes of polymer surfaces caused by exposure to cold plasma have been previously reported (U. Lommatzsch, M. Noeske, J. Degenhardt, T. Wubben, S. Strudthoff, G. Ellinghorst. O.-D. Hennemann, Pretreatment and surface modification of polymers via atmospheric-pressure plasma jet treatment, in Polymer Surface Modificatio: Relevance to Adhesion, v. 4, ed. by K. L. Mittal, VSP, Leiden, 2007, pp. 25-32; J. P., Fernández-Blázquez, D. Fell, El. Bonaccurso, A. del Campo, Superhydrophilic and superhydrophobic nanostructured surfaces via plasma treatment. J. Colloid and Interface Science 357 (2011) 234-238 and B. Balu, V. Breedveld, D. W. Hess Langmuir 24 (2008) 4785-4790).

Further, it is seen that the wetting properties of the surface are changed by exposure to the plasma.

From Table 2 is seen that the hydrophobicity of the surface increases, from an apparent contact angle of 153° to an apparent contact angle of 180°.

From Table 2 is also seen that contact with plasma changes the surface from being oleophilic to oleophobic to some organic solvents such as dimethylformamide and even superoleophobic to some organic solvents such as dimethylsulfoxide and diiodomethane. Additionally, a sliding angle of 50±5° was established for a 5 μl diiodomethane droplet.

This superoleophobicity can be seen in FIG. 8, a reproduction of a photograph of a 5 microliter diidomethane droplet deposited on a surface as described herein that was exposed with CF₄ plasma. The obtuse apparent contact angle between the surface and the droplet surface is seen.

Additionally, a surface as described herein that was exposed with CF₄ plasma demonstrated increased stability of the Cassie state, established with a water/ethanol solution as described above. As seen in FIG. 7, an apparent contact angle as high as 100° was observed for droplets of a solution with a 60-70 wt % ethanol concentration, corresponding to a surface tension as low as 30 mJ/m² (see FIG. 6).

As discussed above with reference to FIG. 4B, the exposure to CF₄ plasma not only roughened the surface, but also modified the chemical composition thereof by the incorporation of fluorine atoms. Modification of surfaces resulting from exposure to CF₄ has been previously reported (M. Mona, E. Occhiello, R. Marola, F. Garbassi, P. Humphrey, D. Johnson, J. Colloid & Interface Sci. 137 (1990) 11-24; E. Occhiello, M. Mona, F. Garbassi, Applied Surface Science, 47 (1991) 235-242; and R. M. France, R. D. Short, Langmuir 14 (17) (1998) 4827-4835).

Although not wishing to be held to any one theory, it is currently believed that in some embodiments, the hydrophobicity and oleophobicity of a featured surface exposed to plasma as described herein is caused by changes in topography (smoothness) caused by etching of the featured surface by the plasma, including of the protrusions. Although not wishing to be held to any one theory, it is currently believed that in some embodiments, the increased hydrophobicity and oleophobicity of a surface as described herein are caused by the incorporation of atoms (such as fluorine) into the surface as a result of the exposure to plasma, exclusively or in addition to the effect of the etching.

Exposure of polymers to plasma to effect wettability of polymers has been disclosed (J. P., Fernández-Blázquez, D. Fell, El. Bonaccurso, A. del Campo, Superhydrophilic and superhydrophobic nanostructured surfaces via plasma treatment. J. Colloid and Interface Science 357 (2011) 234-238; B. Balu, V. Breedveld, D. W. Hess Langmuir 24 (2008) 4785-4790; M. Morra, E. Occhiello, R. Marola, F. Garbassi, P. Humphrey, D. Johnson, J. Colloid & Interface Sci. 137 (1990) 11-24; E. Occhiello, M. Mona, F. Garbassi, Applied Surface Science, 47 (1991) 235-242; R. M. France, R. D. Short, Langmuir 14 (17) (1998) 4827-4835; R. M. France, R. D. Short, J. Chem. Soc., Faraday Trans. 93 (1997) 3173-3178).

It is known that polymers exposed to plasma demonstrate slow change of wetting properties called “hydrophobic recovery” (Al. Kaminska, H. Kaczmarek, J. Kowalonek, J. European Polymer 38 (2002) 1915-1919). For instant, polymers rendered hydrophilic by exposure to plasma become more hydrophobic with time (Al. Kaminska, H. Kaczmarek, J. Kowalonek, J. European Polymer 38 (2002) 1915-1919; M. Mortazavi, M. Nosonovsky Applied Surface Science, 258 (2012) 6876-6883). The mechanism of hydrophobic recovery is unknown. In FIG. 7 is seen that the stability of the Cassie wetting improves with time for surfaces as described herein exposed to plasma after 9 days. An apparent contact angle as high as 120° was observed for water/ethanol solutions with the concentration of ethanol of 60 wt %.

It is appreciated that certain features of the invention, which are, for clarity, described in the context of separate embodiments, may also be provided in combination in a single embodiment. Conversely, various feature is of the invention, which are, for brevity, described in the context of a single embodiment, may also be provided separately or in any suitable subcombination or as suitable in any other described embodiment of the invention. Certain features described in the context of various embodiments arc not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

1-42. (canceled)

43. A method of making a featured surface, comprising:
providing a material;
contacting a mesh with a surface of said material;
separating said mesh from said surface to form a plurality of tapering protrusions protruding from said surface, thereby making a featured surface on said material,
wherein said featured surface is substantially more hydrophobic than the inherent hydrophobicity of said material.

44. The method of claim 43, wherein said featured surface has an apparent contact angle at least 20° greater than the Young equilibrium contact angle of said material.

45. The method of claim 43, wherein the separation between neighboring voids of said mesh is not more than 200 micrometers and not less than 0.2 micrometers.

46. The method of claim 43, wherein the density of voids of said mesh is not more than 10×10⁶ voids/mm² and not less than 10 voids/mm².

47. The method of claim 43, wherein the size of voids of said mesh is not less than 0.031 micrometer² and not more than 17670 micrometer².

48. The method of claim 43, wherein said contacting comprises impressing said mesh into said surface.

49. The method of claim 43, wherein said material is a thermoplastic material.

50. The method of claim 49, further comprising: heating said surface during at least part of at least one of said contacting said mesh with said surface and said separating said mesh from said surface.

51. The method of claim 43, wherein said mesh is a woven mesh.

52. The method of claim 43, wherein said protrusions are in a twisted form.

53. The method of claim 43, further comprising: subsequent to said separating said mesh from said surface, exposing said featured surface with said plurality of tapering protrusions to a plasma.

54. The method of claim 53, wherein conditions of said exposure of said featured surface to said plasma are effective in substantially increasing the hydrophobicity of said featured surface.

55. The method of claim 54, wherein subsequent to said exposure to plasma, said featured surface has an apparent contact angle with water at least 5° greater than the apparent contact angle of said featured material prior to said exposure to plasma.

56. The method of claim 53, wherein conditions of said exposure of said featured surface to said plasma are effective in substantially increasing the oleophobicity of said featured surface.

57. The method of claim 53, said plasma comprising a cold plasma.

58. A man-made featured surface, comprising as features, a plurality of tapering protrusions protruding from a surface,
wherein said surface and said protrusions are of a same material,
said protrusions having a length of not more than 1000 micrometers and not less than 0.5 micrometers;
wherein a density of said protrusions on said surface is not less than 10 protrusions/mm²; and
wherein neighboring protrusions on said surface are separated by a center to center distance of not more than 200 micrometers and not less than 0.2 micrometers.

59. The surface of claim 58, wherein the featured surface is substantially more hydrophobic than the inherent hydrophobicity of said material.

60. The surface of claim 59, wherein said featured surface has an apparent contact angle at least 20° greater than the Young equilibrium contact angle of said material.

61. The surface of claim 58, wherein said material is hydrophobic, and said featured surface is superhydrophobic.

62. The surface of claim 58, wherein said material is hydrophilic, and said featured surface is hydrophobic.

63. The surface of claim 58, wherein said material is hydrophilic, and said featured surface is superhydrophobic.

64. The surface of claim 58, wherein a density of said protrusions on said surface is not more than 10×10⁶ protrusions/mm².

65. The surface of claim 58, wherein said protrusions have a base size of not less than 0.031 micrometer².

66. The surface of claim 58, wherein said material is a man-made material.

67. The surface of claim 58, wherein said material is a thermoplastic material.

68. The surface of claim 58, wherein said protrusions are in a twisted form.

69. The surface of claim 58, wherein said protrusions are substantially uncoated and the outer surface thereof is of said material.

70. The surface of claim 58, wherein surfaces of said protrusions have nanometric roughness.

71. The surface of claim 58, wherein surfaces of said protrusions include bonded atoms different from said material.

72. An item of manufacture, comprising a featured surface of claim 58.
